(19) United States
(12) Patent Application Publication
(10) Pub. No.: US 2009/0234764 A1
(43) Pub. Date: Sep. 17, 2009

(54) SYSTEMS AND METHODS FOR BIOMETRIC AUTHENTICATION OF MONETARY FUND TRANSFER

(76) Inventor: Mark FRIESEN, Portland, OR (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/049,197

(22) Filed: Mar. 14, 2008

(51) Int. Cl. G06Q 40/00; G06Q 10/00

(52) U.S. Cl. 705/35

(57) ABSTRACT

An embodiment relates generally to a method of authenticating a monetary fund transfer. The method includes receiving a monetary fund transfer request that includes a declared identity of a sender and an identity of a recipient, retrieving biometric data from the sender, and determining whether or not a biometric template associated with the declared identity is available. The method also includes verifying the declared identity by comparing the retrieved biometric data with the biometric template, if the biometric template is available. The method further includes determining a compliance status of the transfer request in a governing jurisdiction of the sender based on the retrieved biometric data and/or the verified identity of the sender.

### FIELD

This invention relates to systems and methods for authenticating a monetary fund transfer using biometric data.

### DESCRIPTION OF THE RELATED ART

A monetary fund transfer is a process where one individual or entity can transfer money electronically to another individual and/or entity. The fund transfer may involve an account at either end-point or actual cash. More particularly, the fund transfer may involve cash, direct account credits and debits, stored value debit cards, phone-based prepaid accounts, and/or other stored-value products at either end of the fund transfer. In 2006, about $300 billion was transferred between individuals across national borders and it is estimated that ten times that amount was transferred in intra-national transactions.

A monetary funds transfer may also occur between accounts of one individual and/or entity, such as stored value products and electronic cash vehicles owned by the same individual. These funds transfers are often termed “me-to-me” transfers. For example, an individual and/or entity may wish to add value to a prepaid account (e.g. mobile phone prepaid account) from another account or may desires to move money between existing accounts (e.g. a brokerage account and a normal demand deposit account).

A monetary fund transfer service is typically broken down into three components: first-mile, intermediary, and last-mile. A first-mile agent provides services at the point of origin. A last-mile agent provides services at the destination point for the transfer. An intermediary is any agent that provides settlement services to help complete the transaction and provide payment settlement between the first-mile and last-mile services. Multiple intermediaries may be involved in a single transfer.

Fund transfers, especially if the first-mile and last-mile components are in different nations, are more highly regulated than purchase transactions because of the peer-to-peer nature of a fund transfer. Anyone can transfer funds without clearly indicating the reason for the transfer of funds, such as exchanging money for goods or services. As a result, fund transfers are a common method for illicit activities such as money laundering, concealing assets, funding illegal activity or terrorism, and committing fraud. Detecting such illicit activities associated with fund transfers requires identifying an individual across multiple transactions, even when the individual does not have and/or is not required to present any form of identification.

However, in many cases, reliable and efficient identification of individuals is particularity problematic for monetary fund transfers. For example, many fund transfers involve at least one individual or entity that does not have adequate government-issued identification, and even when identification is provided, first-mile and last-mile agents that rely on a visual inspection of the identification are easily corrupted through bribery and intimidation. Moreover, many individuals are reluctant to give detailed information about themselves or their bank accounts to last-mile agents or directly to someone transferring funds to them. Also, last-mile agents for international find transfers are often in remote areas and have limited access to technology or resources to properly identify individuals.

### SUMMARY

An embodiment relates generally to a method of authenticating a monetary fund transfer. The method includes receiving a monetary fund transfer request that includes a declared identity of a sender and an identity of a recipient, retrieving biometric data from the sender, and determining whether or not a biometric template associated with the declared identity is available. The method also includes verifying the declared identity by comparing the retrieved biometric data with the biometric template, if the biometric template is available. The method further includes determining a compliance status of the transfer request in a governing jurisdiction of the sender based on the retrieved biometric data and/or the verified identity of the sender.

Another embodiment pertains generally to a system for authenticating a monetary fund transfer. The system includes a network configured to provide communication services and a plurality of transfer agents coupled to the network. The system also includes a compliance checking service coupled to the network. The compliance checking service is configured to receive a monetary fund transfer request from a first transfer agent of the plurality of transfer agents, where the transfer request includes a declared identity of a sender and an identity of a recipient, to retrieve biometric data from the sender, and to determine whether or not a biometric template associated with the declared identity is available. The compliance checking service is also configured to verify, if the biometric template is available, the declared identity by comparing the retrieved biometric data with the biometric template, and to determine a compliance status of the transfer request in a governing jurisdiction of the sender by using the retrieved biometric data and/or the verified identity of the sender.

Yet another embodiment relates generally to an apparatus for authenticating a monetary fund transfer. The apparatus includes a plurality of transfer agents coupled with a communication medium and an internal database configured to store biometric verification information. The apparatus also includes a rules database configured to store a plurality of rules, each rule specifying at least one condition for a legal transfer of monetary fund between the transfer agents. The apparatus further includes a compliance checking processor configured to receive a monetary fund transfer request from a first transfer agent of the plurality of transfer agents, where the transfer request includes a declared identity of a sender and an identity of a recipient, to retrieve biometric data from the sender, and to determine whether the biometric verification information associated with the declared identity is available. The compliance checking service is also configured to verify, based on a determination that the biometric verification information is available, the declared identity by comparing the retrieved biometric data with the biometric verification information, and to determine, based on one of the retrieved biometric data and the verified identity of the sender, the compliance status of the transfer request according to the plurality of rules.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an exemplary block diagram of a system for authenticating monetary fund transfers in accordance with various embodiments;

FIG. 2 illustrates an exemplary block diagram of a monetary fund transfer agent in accordance with various embodiments;

FIG. 3 illustrates an exemplary flow diagram for enrollment service in accordance with various embodiments;

FIGS. 4A-C show exemplary flow diagrams in accordance with various embodiments; and

FIG. 5 illustrates an exemplary flow diagram for legal compliance checking service in accordance with various embodiments.

It will be appreciated that for simplicity and clarity of illustration, elements shown in the drawings have not necessarily been drawn to scale. For example, the dimensions of some elements are exaggerated relative to each other. Further, where considered appropriate, reference numbers have been repeated among the drawings to indicate corresponding elements and a repetitive explanation thereof will be omitted.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of financial systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments relate generally to systems and methods for authenticating an electronic fund transfer using biometric data. More particularly, a sender of electronic funds from an account (e.g., a bank account, stored value product, electronic cash, etc.) can initiate a fund transfer using a biometric fund transfer system. The biometric fund transfer system can comprise an authentication center which is coupled to multiple agent modules. The agent modules can be located at distributed physical locations such as kiosks, representative stores, financial institutions, etc. However, the sender can also access the biometric fund transfer system through a variety of other means such as telephone, web access etc. Each of these other access methods to the biometric fund transfer system can have a respective biometric input adapted to the means of access. For example, for telephone access, the respective biometric input can be a voice scanner to verify the identity of the caller.

The biometric fund transfer system can process fund transfers by having the sender self-report his/her identity. For those instances where the sender is at a physical location that provides access to the biometric fund transfer system to request a fund transfer, the sender can provide a pre-established identifier such as log-in, a password, etc. and a biometric sample to an origin agent module. The origin agent module can be configured to request from the authentication center for a biometric template associated with the pre-established identifier. If the authentication center returns the requested biometric template, the agent module can verify the identity of the sender by comparing the biometric template with the sampled biometric data. Subsequently, the origin agent module can indicate the identity of the sender has been biometrically authenticated and can forward the requested transfer to the authentication center for further processing.

In the event that a biometric template is not returned from the authentication center, the requested transfer can still continue. More particularly, the agent module can store the sampled biometric data of the data to be forwarded to the authentication center to be used in subsequent transactions. Alternatively, a service agent can collect and verify the secondary ID of the sender to create a dossier that is stored at the local agent module along with the transaction history of the sender. The agent module can then return a pre-established identifier to be used in subsequent transactions. In some embodiments, the biometric fund transfer system can allow a transaction to occur without verification in the event of the amount of money being transferred is below a predetermined threshold amount.

After the verification of the sender is completed, the requested transfer along with all the transactional information is forwarded to the authentication center. The transactional information can include the name of the recipient, destination account (if applicable), address of the recipient, etc. In some instances, a unique transaction ID can be generated for the requested transaction. If the transaction ID is used, the recipient may or may not be required to biometrically authenticate.

The authentication center can be configured to hold the requested transfer until a biometric verification of the recipient is completed. The authentication center may send a request to a destination agent module to obtain the authentication of the recipient. More particularly, the recipient can self-report his identity by providing a pre-established identifier, a password or secondary ID. The destination agent module can request a biometric template from the authentication center based on the pre-established identifier and take a biometric data sample of the recipient. If a biometric template is returned from the authentication center, the destination agent module can biometrically verify the identity of the recipient with the biometric template with the sample of biometric data. If there is match, the destination agent module can notify the authentication to finish processing the requested transfer. If there is not a match, the requested transfer can be cancelled.

If a biometric template is not returned from the authentication sample, a local service agent can collect secondary ID to verify the identity of the user. A local dossier file can be created of the secondary ID along with the transaction history for subsequent transactions. With the recipient consent, the sampled biometric data can be forwarded and stored in the authentication center and a pre-established identifier can be returned to the recipient for future transactions.

In some embodiments, the authentication center can be configured to determine whether a requested transfer complies with all applicable regulatory requirements. More particularly, after the sender and the recipient have been authenticated, the authentication center can execute a compliance check on the requested transfer. If the compliance check passes, the authentication center lets the requested transfer to occur. Otherwise, if the compliance check fails, the authentication may cancel the requested transfer and notify the appropriate authorities.

It should be readily obvious to that the origin agent modules and the destination agent modules have complementary roles as origin and destination agent modules. For example, an origin agent module would perform the same functions as the destination agent module if the origin agent module were designated as a destination and vice versa.

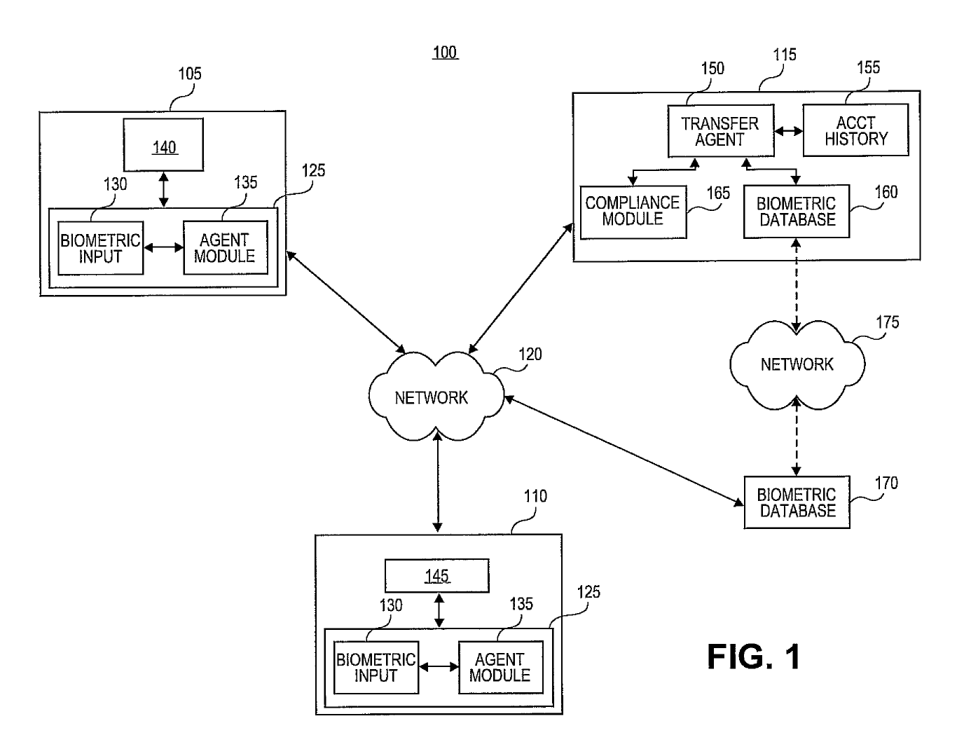

FIG. 1 illustrates an exemplary biometric transfer fund system 100 (hereinafter “system”) for authenticating electronic monetary fund transfers in accordance with various embodiments. It should be readily apparent to those of ordinary skill in the art that the system 100 depicted in FIG. 1 represents a generalized schematic illustration and that other components may be added or existing components may be removed or modified.

As shown in FIG. 1, the system 100 can comprise an origin or first mile station 105, a destination or last mile station 110, an authentication center 115, and a network 100. Although FIG. 1 depicts a singular instance of the origin station 105 and destination 110, the system 100 can comprise of multiple instances of the respective stations (105, 110).

It should be readily obvious to one of ordinary skill in the art that the origin and destination stations 105, 110 and the authentication center 115 can be implemented using software components, hardware components or any combination thereof. In software embodiments, the components of the stations 105 and the authentication center 115 can be implemented using computer languages such as C, C++, object oriented programming languages or other programming languages. In hardware embodiments, the components of the stations 105, 110 and BBC agent module 115 can be implemented using a processor, microcontroller, an application specific integrated circuit, EEPROM or other programmable devices.

The stations 105 and 110 have dual roles as sender and a recipient depending on their particular role in a transaction. As such, the discussion of the origin station 105 as a sender and recipient station can be equally applied to the destination station 110. More particularly, the origin station 105 can comprise a facility 125, which can be a kiosk, a storefront, a terminal in a financial institution, and in some instances users on the Internet. Contained with the facility 125 can be a biometric input module 130 and an agent module 135.

The biometric input module 130 can be configured to provide input means for sampling biometric data from a sender 140 wishing to electronically transfer funds to an intended recipient 145 at the destination station 110. Each facility 125 may not have the same biometric input means. For example, a rural facility 125 may only have a voice scanner or fingerprint scanner whereas an urban facility 125 can have multiple mechanisms: voice scanner, retinal scanner, facial recognition, etc. The data from the input module 130 can be transferred to the agent module 135 to authenticate the identity of the sender 140 as previously described and in greater detail below.

The authentication center 115 can comprise a transfer agent module 150, an account history module 155, a biometric database 160 and a compliance module 165. The components of the authentication center 115 can be implemented using software components, hardware components or any combination thereof. In software embodiments, the components of the authentication center 115 can be implemented using computer languages such as C, C++, object oriented programming languages or other programming languages. In hardware embodiments, the components of the agent module 115 can be implemented using a processor, microcontroller, an application specific integrated circuit, EEPROM or other programmable devices.

The transfer agent 150 can be configured to vet a requested electronic fund transfer between origin station 105 and destination station 110 as a non-limiting example. For example, the transfer agent 150 can ensure that the identity of the sender has been biometrically verified as well as the identity of the recipient 145 biometrically verified. The transfer agent 150 can also vet the requested transfer as complying with all applicable regulatory requirements for electronic funds. The transfer agent 150 can be further configured to record all transactions between senders, recipients, and amounts in order to provide additional data for data mining for non-compliant electronic fund transfer.

The transfer agent 150 can be coupled to the account history module 155, which is configured to store the transactions that occur through the authentication center 115. The account history module 155 can be implemented in a database, a linked list, a table or other similar referencing data structure.

The transfer agent 150 can also be coupled with a biometric database 160, which is configured to store any biometric data associated with a user of the system 100. The biometric database 160 can store information as fingerprints, retinal scans, voice scans, pin numbers, digital images of photo-identification or other means of unique identifiers. Each user can have a certain subset of biometric data which can then be indexed by a user identifier such as the user or login ID. The search results returned from the biometric database 150 can be referred to as biometric templates.

In some embodiments, the services of the biometric database 160 can be supplied by a third party. For example, biometric database 170 can be a located at a third party website, which is coupled to the authentication center 115 by a secure network 175. Accordingly, the transfer agent 150 can be configured to forward requests for biometric templates of senders/recipients to the biometric database 170 as messages or callback functions over the network 175 similar to what GOOGLE MAPS does to MAPQUEST when requesting latitude/longitude coordinates.

The transfer agent 150 can also be coupled to the compliance module 165. The compliance module 165 in conjunction with a rules database (not shown) can be configured to determine whether or not a transfer request is legal or in compliance with regulations and rules for a monetary fund transaction in the governing jurisdictions. Additional information of the compliance module 165 can be found in U.S. patent application Ser. No. 11/939,932, filed on Nov. 14, 2007, common inventor and common assignee, which is hereby incorporated by reference in its entirety.

The origin station 105, the destination station, and the authentication center 115 are coupled to network 120 via respective local network connections through respective computer devices as known to those skilled in the art. The local network connection can be a local area network (wired or wireless), a wide area network or combinations thereof implementing network protocols such as TCP/IP, ATM, SONET, or other known network protocols. The local network connection can also be part of a network that provides access to the network 120, which can be the Internet or some large conglomeration of existing networks.

In accordance with various embodiments, the origin station 105 and destination station 105 can each operate as the complementary station depending on the roles of the requested electronic fund transfer. As such, in a sender role, origin station 105 and destination station 110 initiate and execute the same functions. Similarly, in a destination role, origin 105 and destination station 110 initiate and execute the same functions.

As such, in a sender role, a sender can enter the facility 125 of a station (105, 110) and request an electronic fund transfer to a recipient. A service agent (not shown) can enter the appropriate information for the electronic fund transfer into the agent module 135. The information can include name of sender and recipient, respective addresses, respective places of work, respective telephone numbers. The service agent can also request that the sender submit biometric samples of herself through the available biometric input means (e.g., facial recognition, finger print scanner, retinal scanner, voice scanner, etc.). The electronic fund transfer information and the sampled biometric data if any.

The agent module 135 can then request a biometric template from the authentication center 115 based on a user ID. If the query returns a biometric template, the agent module 100 can verify the identity by comparing the sampled biometric data with the received biometric template from the biometric database 160 of the authentication center 115.

Otherwise, if the query returns no biometric template, then the agent module 135 may require additional proof of identity from the sender through non-biometric means. For example, the service agent may require exemplars of paper identification such as social security cards or equivalents, which are entered into the agent module 135. The paper identification and any sampled biometric data can be stored as a biometric template in the biometric database 160. Subsequently, the agent module 135 can forward a message to the authentication center 115 that the identity of the sender has been biometrically authenticated and the information associated with the electronic fund transfer.

The authentication center 115 can store the information related to the request transaction in the account history module 155. The authentication center 115 can also put a hold on the transfer until the identity of the recipient is authenticated. In this regard, the authentication center 115 can be configured to send a message to the destination station 110 for the recipient to authenticate his identity.

In some embodiments, the authentication center 115 can determine that the recipient has previously been authenticated and may let the requested transaction to proceed but still wait for biometric authentication at the destination station 110.

In the destination role, a service agent of the stations (105, 110) can receive the intended recipient 145 in the facility 125. The service agent may inform the intended recipient 145 that there is a transfer awaiting his authentication. The service agent may then request that the intended recipient 145 provide a user ID and a sample of biometric data through the available biometric input means (e.g., voice exemplar, retinal scan, fingerprint, facial recognition, etc.) to the agent module 135.

The agent module 135 can query the biometric database 160 for biometric template based on the user ID.

If the biometric template is available, the agent module 135 can verify the recipient's identity by comparing the sampled biometric data with the received biometric template. Otherwise if the query returns no biometric template, the agent module 135 may require additional proof of identity from the recipient through non-biometric means. The service agent would enter the non-biometric data along with any sampled biometric data into the agent module 135. The agent module 135 can transmit this information to the biometric database 160 to be used as a subsequent biometric template for that user. The agent module 135 can forward the biometric authentication results to the authentication center 115.

The authentication center 115 can be configured to check the transaction against the compliance module 165 to ensure that the transaction does not run afoul of any existing regulatory restrictions in response to the biometric authentication of the intended recipient 145. In the event that the intended recipient 145 had already been verified by previous transactions from the account history module 155, the transfer agent 150 can run the requested transaction against the compliance module 165.

If the requested transaction qualifies as a legal transaction, the transfer agent 150 can inform that agent module 135 at the destination station 110 to release the funds. Otherwise, the authentication center 115 can terminate the transfer request and may notify proper governmental authority if the transfer request appears to run afoul against the compliance module 165.

In some instances, the requested information from the sender 140 or the recipient 145 can be inadequate; the authorization center 115 can be configured to utilize third party databases, business information sources, and other electronic databases to search for the missing information. In some embodiments, the authentication center 115 can also query third party databases, sources, etc., to verify the identity of the sender 140 or recipient 145 of the requested fund transfer in the event that the internal database does not contain the necessary information. For example, a transfer request may list a newly created business as a recipient account holder. The authentication center 115 can be configured to search third party databases such as state databases for incorporation information, Dun & Bradstreet™, Lexis-Nexis™ or other similar electronic databases for legitimate business entities. The authentication center 115 can also access public record databases such as telephone directory databases, public record databases, etc., to verify the identities of individuals in the fund transfer request.

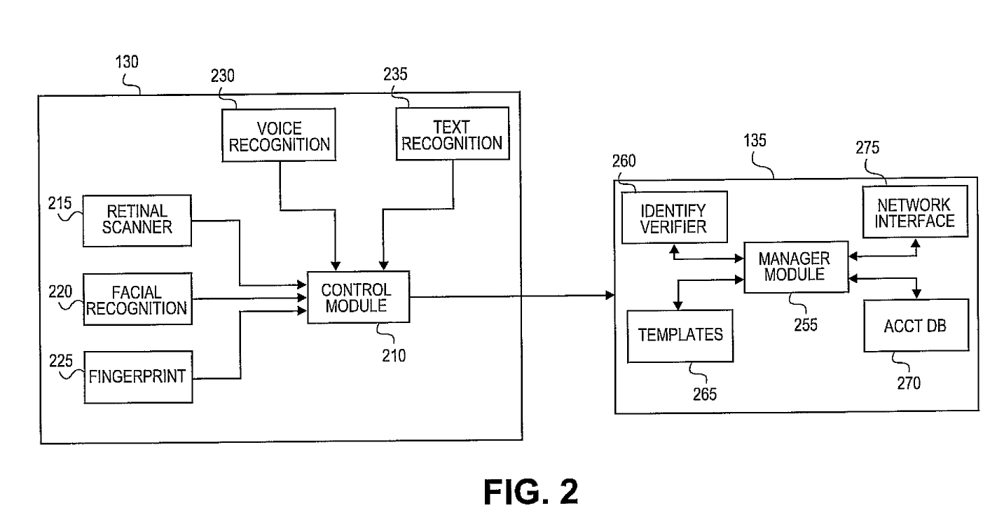

FIG. 2 illustrates a detailed block diagram of the facility 125 for the origin station 105 and the destination station 110 in accordance with various embodiments. It should be readily apparent to those of ordinary skill in the art that the facility 125 depicted in FIG. 2 represents a generalized schematic illustration and that other components may be added or existing components may be removed or modified.

As shown in FIG. 2, the facility 125 can comprise the biometric input 130 and the agent module 135. The biometric input 130 can comprise a control module 210, which is coupled to biometric data inputs 215-235. The control module 210 can also be coupled to the agent module 135. In certain embodiments, controller module 210 can be configured to sample biometric data from either a sender 140 or intended recipient 145 via a retinal scanner 215, facial recognition 220 (which would include a camera, processing platform and appropriate software), fingerprint scanner 225, voice recognition module 230, keystroke recognition 235, or a similar biometric device coupled to the control module 210. The control module 210 can sample the sender's 140 or the intended recipient's 145 biometric data by the respective input means and forward the sampled biometric data to the agent module 135. As noted previously, each origin station 105 or destination station 110 can have all or a subset of the biometric input means. The distribution of biometric input means 215-235 can based on cost, security, educational level of the customers, the availability of telecommunication resources, etc.

The agent module 135 can comprise a manager module 255, an identity verifier 260, a biometric templates storage module 265, and an accounts database 270. The manager module 255 can be configured to receive the sampled biometric data from the biometric input 130 and cache the sampled biometric data in the identify verifier 260. The identify verifier 260 can be configured to compare the sampled biometric data with a requested biometric template. The identify verifier 260 can then output the results of authentication to the manager module 255. The manager module 255 can then be configured to forward a request transaction along with indication that the sender 140 identity has been biometrically authenticated to the authentication center 115.

The manager module 255 can be also coupled to the accounts database 270. The accounts database 270 provides a local transaction history for a particular station 105 or 110 as well as accounts for the users who use the respective station 105 or 110. The accounts of the users can also be used by the manager module 255 in the authentication process.

The manager module 255 can be further coupled to a network interface module 275, which is configured to provide a communication interface to the network 120. The manager module 255 can then use the network interface module 275 to transfer all the appropriate information between the authentication center 115 and itself.

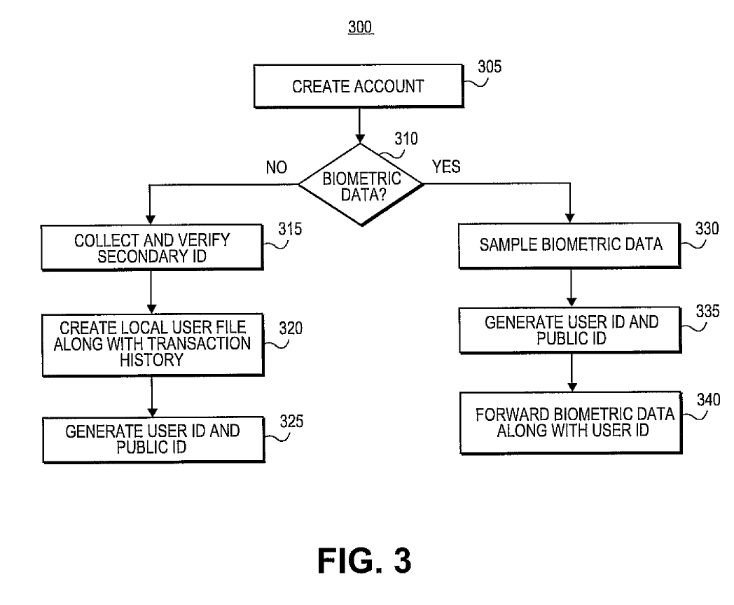

FIG. 3 shows an exemplary registration flow diagram 300, executed by the agent module 135, in accordance with various embodiments. It should be readily apparent to those of ordinary skill in the art that the flow diagram 300 depicted in FIG. 3 represent a generalized schematic illustration and that other steps may be added or existing steps may be removed or modified.

As shown in FIG. 3, a potential new user can enroll in the biometric fund transfer system 100 by accessing the system 100 to create an account in step 305. A user can access the system 100 by a variety of means such as web-access, telephone or at physical locations of the agent modules. Each access method can be configured with an appropriate biometric input means. For example, web-access may include a camera coupled with facial recognition software to verify the identity of the user. A kiosk can use a fingerprint scanner.

In step 310, a user can be presented with an option to provide biometric data or user secondary ID (e.g., drivers license, passport, or other forms of government identification). If a user chooses not to provide biometric data, the user can present the secondary ID to a service agent, in step 315. The service agent can verify the secondary ID.

In step 320, the service agent can create a local user file that contains digital images of the secondary ID along with a transaction history, i.e., a local dossier file, which is stored in the local agent module 135.

In step 325, the local agent module 135 can generate a user or log-in ID for the newly created account and well as public transaction ID. The public transaction ID can be used by the user to inform potential senders of the account to transfer thereto.

Returning to step 310, if the user want to provide the biometric data, the user can provide a biometric data sample, in step 330. The type of biometric data can be dependent on the access method to biometric fund transfer system. If the user is at a store location, the store may only have a voice scanner. A kiosk access may only a fingerprint scanner. Financial institutions may have retinal scanners. In most instances, the agent module 135 can be used.

In step 335, a user or login ID can be generated along with a public transaction ID can be generated. The user can be handed copies of the user ID and public transaction ID to be used in future transactions. In step 340, the biometric data can be uploaded to the authentication center 115 to be loaded and stored associated with the user ID in the biometric database 160.

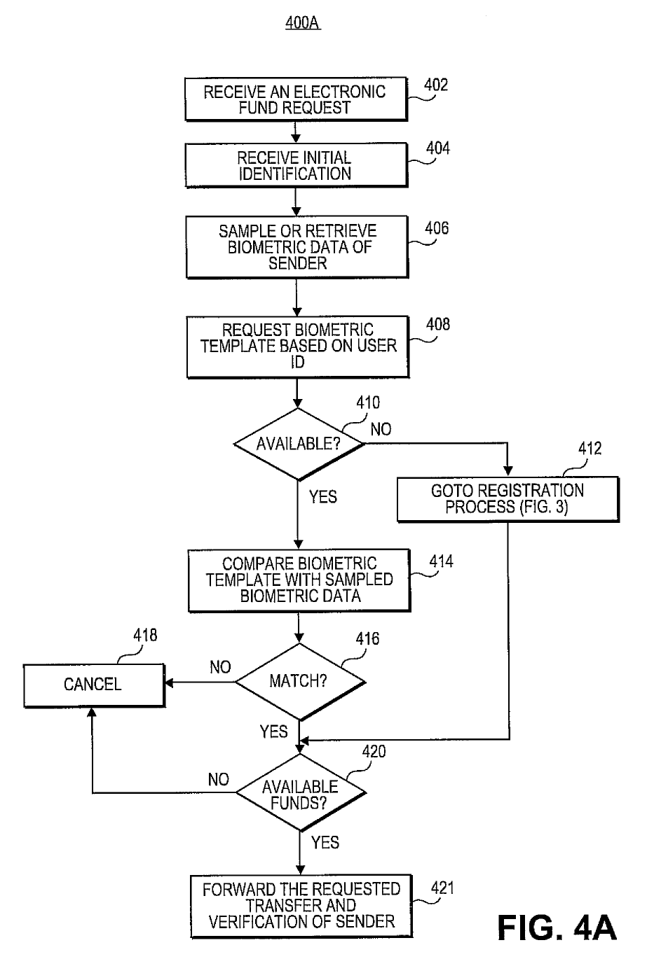

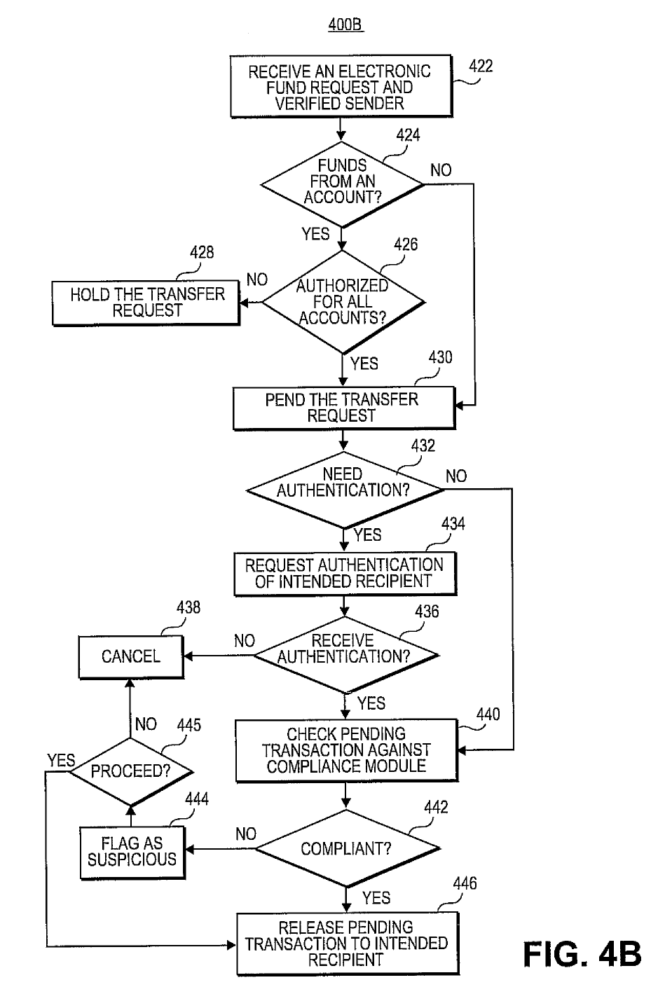

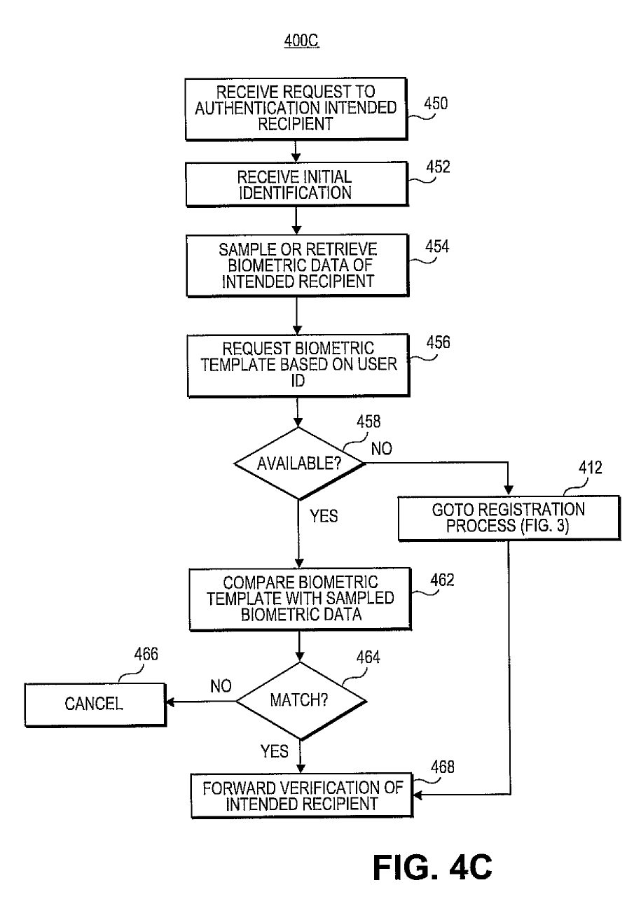

FIG. 4A shows an exemplary flow diagram 400A executed by the agent module 135 in accordance with various embodiments. It should be readily apparent to those of ordinary still in the art that the flow diagrams depicted in FIG. 4A represent a generalized schematic illustration and that other steps may be added or existing steps may be removed or modified.

As shown in FIG. 4A, in step 402, the manager module 255 of the agent module 135 can be configured to receive a monetary fund transfer request from the sender 140. In some embodiments, the transfer request can include associated transaction information such a declared identity (e.g., a pre-established identifier, a name, a government-issued identifier, etc.) of the sender 140, an intended recipient 145 or recipient account, an amount to be transferred, the public transaction ID, etc.

In step 404, a service agent can be presented with an initial set of identification of the sender 140. For example, the user can present the user ID, a password or secondary ID.

In step 406, the agent module 135 can be configured to retrieve or sample the biometric data of the sender 140 from the biometric input 130. For example, retinal image data may be used if the sender 140 makes the transfer request in-person, voice biometric data may be used if the sender 140 makes the transfer request over the phone, while fingerprint data may be used if the sender 140 makes the transfer request at a computer kiosk.

In step 408, the agent module 135 can be configured request a biometric template for the sender 140 based on a user ID. More specifically, the agent module 135 can forward a message requesting a biometric template with the associated user ID through the network interface module 275 to the authentication center 115.

In step 410, the authentication center 115 can forward a return message with the results of the request that includes whether or not a biometric template was found. If the authentication center 115 determines that a biometric template is available, the biometric template is retrieved from the biometric template storage 265 to be forwarded to the agent module 135, which temporarily stores the biometric template.

In step 414, the manager module 255 can invoke the identity verifier 260 to compare the sampled biometric data with the received biometric template. If there is not a match in step 416, the manager module 255 can be configured to cancel the requested transaction, in step 418. Otherwise, if there is a match, the manager module 255 can be configured to determine the availability of funds from either cash by the sender 140 or in an existing account by searching the local account database 270, in step 420. If there are no funds available, the manager module 255 can be configured to cancel the requested transaction, in step 418. Otherwise, the manager module 255 can be configured to forward the requested transfer along with transactional information and an authentication of the sender 140 to the authentication center 115, in step 421. The manager module 255 can also generate a unique transaction ID for the requested transfer. The sender can forward the transaction ID to the recipient so as the recipient can identify the requested transaction with or without biometric authentication.

Returning to step 410, if the biometric template is not available, the manager module 255 can be configured to enroll the sender 140 as previously described with respect to FIG. 3, in step 412.

Returning to step 416, in some embodiments, in the event of a mismatch between the sampled biometric data and the biometric template, the sampled biometric data may be searched against databases to identify possible criminals, terrorism suspects or other people engaged in illicit activities.

In some requested transfers, the source of finds can be an account. In this event, a comparison can be made by the agent module between the identity of the sender 140 and any other party that has debit authorization on the account. If the account requires multiple authorizations, the requested transfer can be placed on hold until all authorizations are completed. The authorizations can be accomplished using the biometric techniques previously described and in greater detail below.

FIG. 4B shows an exemplary flow diagram 400B executed by the agent module 135 in accordance with various embodiments. It should be readily apparent to those of ordinary skill in the art that the flow diagrams depicted in FIG. 4B represent a generalized schematic illustration and that other steps may be added or existing steps may be removed or modified.

As shown in FIG. 4B, the transfer agent 150 can be configured to receive the requested transfer request from a origin station 105 along with the indication of an authentication sender, in step 422.

In step 422, the transfer agent 150 can be configured to determine whether or not the sender 140 is sending monetary finds from an account. If the funds are not from an account(s), then the transfer agent 150 proceeds to step 430 of pending the transfer request. Otherwise, in step 426, the transfer agent can be configured to determine whether or not there is authorization from all the account holder(s) to transfer funds from the account.

If the transfer agent 150 determines that there is not authorization from all the account holders, then in step 428 the transfer agent 150 can be configured to hold and not forward the transfer request until authorization from all of the account holders is received. The transfer agent 150 can be configured to receive authorization from account holders using an identity verification process similar to the biometric verification process described herein. Once the transfer agent 150 determines that authorization to transfer funds is received from all the account holders, the transfer agent 150 proceeds to step 430 to hold the transfer request.

Returning to step 426, if the transfer agent 150 determines that authorization is present, the transfer agent 150 can be configured to hold the transfer request, in step 430.

The transfer agent 150 can then determine whether or not there is a need to verify the identity of the named recipient. In most cases, a fund transfer that involves an account will often not require any action to verify the identity of the individual. However, some account products may not sufficiently identify the account holder for money laundering purposes. Also, in some instances, a fund transfer may require a confirmation of acceptance of the funds. Moreover, a fund transfer that results in providing cash to the recipient 145 almost always requires verification of the identity of the recipient 145.

If the transfer agent 150 determines that there is no need to verify the identity of the named recipient, then the transfer agent 150 proceeds to the processing of step 440. Otherwise, in step 434, the transfer agent 150 can request the destination station 110 to authenticate the intended recipient 145. The transfer agent 150 can then enter a wait state until the results of the request return.

In step 436, the transfer agent 150 can receive a message that determines the results of the authentication process on the intended recipient 145. If results reveal no authentication, the transfer agent 150 can cancel the requested transfer. Otherwise, if authentication was a success, the transfer agent 150 can be configured to check the pending transaction again the compliance module 165, in step 442.

If the results of the compliance testing are non-conforming, the transfer agent 150 can flag the pending transaction as suspicious, in step 444. If the pending transaction is flagged, the transfer agent 150 and the compliance module 165 can perform additional testing to confirm that the requested transfer is non-conforming. If the transfer agent confirms that the requested transfer is non-conforming, the transfer agent 150 can be configured to notify the authorities. In embodiments, if a flagged transaction is later determined to be non-conforming, the transfer agent 150 can report the transaction to an authority whether or not the transaction was completed.

After flagging the request, the transfer agent 150 can be configured to determine whether to proceed with the pending transaction. For example, the transaction can be allowed to proceed to prevent the sender from learning the pending transaction is under investigation. If the transfer agent 150 determines not to proceed, in step 438, the transfer agent 150 can cancel the requested transfer.

Otherwise, the transfer agent 150 logs the completed fund transfer in account history database 125 and releases the funds to the destination station 110 for subsequent distribution to the intended recipient 145, in step 446. Subsequently, the transfer agent 150 can be configured to notify the origin station of the completion of the transfer.

FIG. 4C shows an exemplary flow diagram 400C executed by the agent module 135 in accordance with various embodiments. It should be readily apparent to those of ordinary skill in the art that the flow diagrams depicted in FIG. 4C represent a generalized schematic illustration and that other steps may be added or existing steps may be removed or modified.

As shown in FIG. 4C, in step 450, the manager module 255 of the agent module 135 can be configured to receive a request to authenticate the intended recipient 145 for a pending transfer request.

In step 452, a service agent can be presented with an initial set of identification of the recipient 144. For example, the user can present the user ID, a password or secondary ID. In some instances, the intended recipient can also be required to present the transaction ID for the requested transfer.

In step 454, the manager module 255 can notify the service agent to have the intended recipient 145 insert an appropriate body part to the available biometric input 130 to obtain a sample of biometric data of the intended recipient 145.

In step 456, the manager module 255 can be configured request a biometric template for the intended recipient 145 based on a user ID. More specifically, the agent module 135 can forward a message requesting a biometric template with the associated user ID through the network interface module 275 to the authentication center 115.

In step 458, the authentication center 115 can forward a return message with the results of the request that includes whether or not a biometric template was found. If the agent module 135 has received the biometric template, the biometric template is stored in the biometric template storage 265.

In step 462, the manager module 255 can invoke the identity verifier 260 to compare the sampled biometric data with the received biometric template. If there is not a match in step 464, the manager module 255 can be configured to cancel the requested transaction, in step 466. Otherwise, if there is a match, the manager module 255 can be configured to forward the positive results of the authentication of the intended recipient 145 to the authentication center 115.

Returning to step 458, if the biometric template is not available, the manager module 255 can be configured to enroll the intended recipient 145 as described in FIG. 3 in step 460.

In some requested transfers, the destination of funds can be an account. In this event, a comparison can be made by the agent module between the identity of the recipient 145 and any other party that has credit authorization on the account. If the account requires multiple authorizations, the requested transfer can be placed on hold until all authorizations are completed. The authorizations can be accomplished using the biometric techniques previously described and in greater detail below.

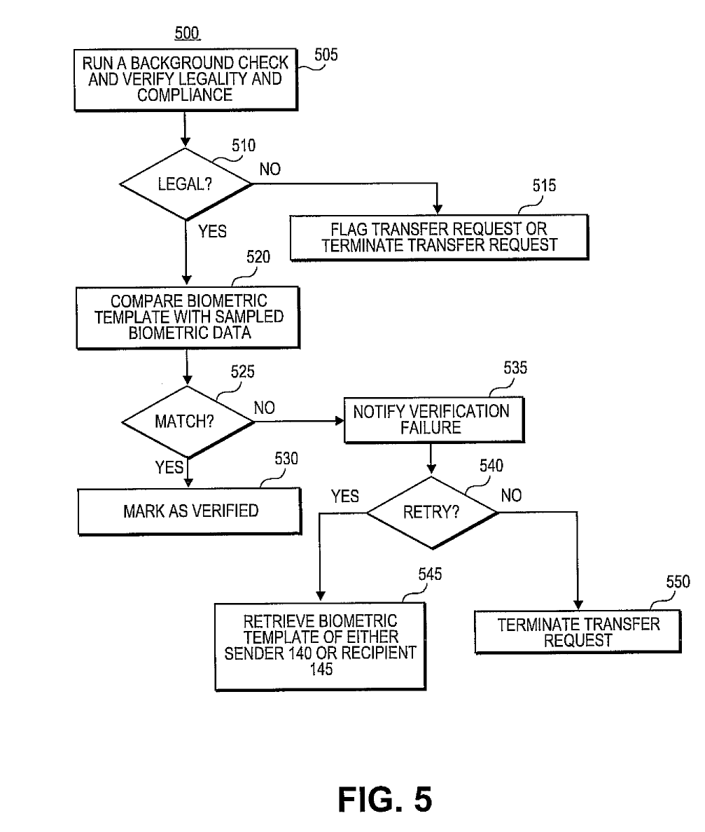

FIG. 5 illustrates an exemplary flow diagram for a legal compliance checking service 500 in accordance with various embodiments. The initial step is to retrieve the verified identity or the biometric data of one of the individuals (e.g., the sender 140 or the recipient 145) involved in the transfer request. Then, in step 505, the transfer agent 150 can be configured to run a background check on the individual by searching the external biometric database 170 of known or suspected lawbreakers using either the verified identity or the biometric data of the individual, and to check whether or not the transfer request is legal or in compliance with regulations and rules for a monetary fund transaction in the governing jurisdictions of the individuals involved in the fund transfer.

In step 510, if the transfer agent 150 locates the individual in the external biometric database 170 or determines that the transfer request violates applicable laws or is not in compliance with applicable regulations and rules, then in step 515, the transfer agent 150 can flag the pending transaction as suspicious.

Alternatively, in step 515, the transfer agent 150 can be configured to notify the appropriate governmental authority, terminate the transfer request, and/or log the terminated transfer request in the account history database 155. As such, the compliance module 165 can perform additional testing to confirm that the requested transfer is non-conforming. If the transfer agent confirms that the requested transfer is non-conforming, the transfer agent 150 can be configured to notify the authorities. By flagging the transfer request, the transaction can be allowed to proceed to prevent the sender from learning the transfer request is under investigation.

Alternatively, if the transfer agent 150 does not locate the individual in the external biometric database 170 and determines that the transfer request is legal and in compliance with applicable regulations and rules, then in step 520 and step 525 the transfer agent 150 compares the retrieved biometric data with the biometric template stored in the biometric database 160.

If the transfer agent 150 determines that the retrieved biometric data matches the biometric template of the individual, then in step 530 the transfer agent 150 marks the transfer request as verified and completes the legal compliance checking service 500. Alternatively, if the transfer agent 150 determines that the retrieved biometric data does not match the biometric template, then in step 535 the transfer agent 150 can be configured to notify the origin station 105 or the destination station 110 that verification of the individual's identity has failed, and to proceed to step 540 to determine whether or not the transfer agent 150 should retry verifying the individual's declared identity. If another attempt is made to authenticate the user, the transfer agent 150 may forward a request to the agent module 135 to authenticate, in step 545. Otherwise, if the there no attempt to verify, the transfer agent 150 can be configured to notify the appropriate governmental authority, terminate the transfer request, and/or log the terminated transfer request in the account history database 125, in step 550.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

1. A method of authenticating a monetary fund transfer, the method comprising:
receiving a monetary fund transfer request including a declared identity of a sender and an identity of a recipient;
retrieving a sender biometric data from the sender;
determining whether a first biometric template associated with the declared identity is available;
retrieving, based on a determination that the first biometric template is available, the first biometric template from storage;
verifying the declared identity by comparing the retrieved sender biometric data with the first biometric template; and
determining, based on one of the retrieved sender biometric data and the verified identity of the sender, a compliance status of the transfer request in a governing jurisdiction of the sender before completing the transfer request.

2. The method of claim 1 the method further comprising:
forwarding the transfer request based on a determination that the transfer request is a noncompliant request; and
notifying a government authority in the governing jurisdiction that the transfer request is noncompliant.

3. The method of claim 1, wherein determining a compliance status of the transfer request further comprises:
determining the compliance status of the transfer request according to a set of rules defining regulatory and legal compliance rules for a monetary transfer in the governing jurisdiction of the sender; and
notifying a government authority in the governing jurisdiction of the transfer request as required by a rule in the set of rules.

4. The method of claim 1, wherein determining a compliance status of the transfer request further comprises:
determining the compliance status of the transfer request according to a history of prior transfer requests of the sender.

5. The method of claim 4, the method further comprising:
forwarding the transfer request based on a determination that the transfer request is a noncompliant request; and
notifying a government authority in the governing jurisdiction that the transfer request is noncompliant.

6. The method of claim 1, the method further comprising:
verifying, based on a determination that the biometric template is not available, the declared identity by acquiring a non-biometric identification associated with the sender from the sender; and
storing the acquired biometric data as a new biometric template for the sender in accordance with the non-biometric identification.

7. The method of claim 1, the method further comprising:
retrieving a second biometric data from an individual accepting the monetary fund transfer request;
determining whether a second biometric template associated with the accepting individual is available;
verifying, based on a determination that the second biometric template associated with the accepting individual is available, the accepting individual as the recipient by comparing the retrieved second biometric data with the biometric template and the recipient identity in the transfer request; and
determining, based on one of the retrieved second biometric data and the recipient identity, a compliance status of the transfer request in a governing jurisdiction of the recipient.

8. The method of claim 1, the method further comprising placing a hold on the transfer request based on a determination that additional information is required.

9. The method of claim 8, wherein the monetary fund transfer request comprises a transfer to or from an account, and the method further comprises verifying at least one of the declared identity of the sender and the identity of the recipient is associated with the account.

10. The method of claim 8, the method further comprising maintaining a hold on the transfer request until at least one subsequent event occurs.

11. The method of claim 3, further comprising transmitting a stop fund transfer message in response to a violation of the set of rules, wherein the stop fund transfer message describes a reason for the stop fund transfer message.

12. A system for authenticating a monetary fund transfer, the system comprising:
a network configured to provide communication services;
a plurality of transfer agents coupled to the network; and
a compliance checking service coupled to the network, wherein the compliance checking service is configured to:
receive, from a first transfer agent of the plurality of transfer agents, a monetary fund transfer request including a declared identity of a sender and an identity of a recipient;
retrieve biometric data from the sender;
determine whether a biometric template associated with the declared identity is available;
verify, based on a determination that the biometric template is available, the declared identity by comparing the retrieved biometric data with the biometric template; and
determine, based on one of the retrieved biometric data and the verified identity of the sender, a compliance status of the transfer request in a governing jurisdiction of the sender before completing the transfer request.

13. An apparatus for authenticating a monetary fund transfer, the apparatus comprising:
a plurality of transfer agents coupled with a communication medium;
an internal database configured to store biometric verification information;
a rules database configured to store a plurality of rules, each rule specifying at least one condition for a legal transfer of monetary fund between the transfer agents; and
a compliance checking processor configured to:
receive, from a first transfer agent of the plurality of transfer agents, a monetary fund transfer request including a declared identity of a sender and an identity of a recipient;
retrieve biometric data from the sender,
determine whether the biometric verification information associated with the declared identity is available;
verify, based on a determination that the biometric verification information is available, the declared identity by comparing the retrieved biometric data with the biometric template; and
determine, based on one of the retrieved biometric data and the verified identity of the sender, a compliance status of the transfer request according to the plurality of rules before completing the transfer request
